(19) United States
(12) Patent Application Publication
(10) Pub. No.: US 2014/0106846 A1
(43) Pub. Date: Apr. 17, 2014

(54) Slot Machine Style Game with Randomly Generated Wild Multiplier Symbol

(71) Applicant: AVCOM, INC., Marlboro, NJ (US)

(72) Inventors: Jeremy A. Avin, Marlboro, NJ (US); Brian D. Swift, Brooklyn, NY (US)

(73) Assignee: Avcom, Inc., Marlboro, NJ (US)

(21) Appl. No.: 13/652,123

(22) Filed: Oct. 15, 2012

(51) Int. Cl. A63F 13/00

(52) U.S. Cl. 463/20

(57) ABSTRACT

A method for a slot machine style game is disclosed. The method includes the steps of determining an outcome of the slot machine style game and displaying a plurality of game symbols corresponding to the outcome. At least one of the game symbols is a multiwild symbol, which comprises a wild symbol and has an award multiplier associated therewith. The method also includes the steps of determining whether at least a portion of the plurality of game symbols is a winning combination and when there is a winning combination determining a first award associated with the winning combination. In determining the first award, the multiwild symbol is treated as the wild symbol without the award multiplier. The method also randomly generates the award multiplier; determines a second award based on the first award and the award multiplier; and provides the second award to a player.

### FIELD

The present invention relates to games of chance, wagering games, and gaming methods and devices. More particularly, the present invention relates to a slot machine style game with a wild multiplier symbol.

### BACKGROUND

A slot machine generally comprises a plurality of rotatable reels controlled by a processor. Early slot machines used mechanically rotatable reels, while newer machines use video reels. In response to a wager, the processor randomly selects an outcome from a plurality of possible outcomes and then causes the reels to be rotated and stopped to display the selected outcome. The selected outcome is represented by symbols on the reels. If the selected outcome corresponds to a winning combination identified on a pay table, then the processor instructs a payout mechanism to award a payout for that winning combination to the player in the form of coins, tokens, credits, or other thing of value to the player.

Games that increase player interest are more valuable. In the case of casino-based slot machines, increased player interest results in more money being wagered, and consequently more revenue to the casino. For slot machine style games in which an award is something other than money, increased player interest results in more sharing of game experiences with friends, downloads by interested players, and activity on the game. Thus, any feature that makes games, including slot machine style games, more enticing to players is desirable for the game owner.

One common way to entice more play is to enhance the awards that are paid out. For example, U.S. Patent Application Publication No. 2012/0172109 A1 discloses that a base award can be enhanced by increasing the amount wagered. Thus, for example, the base award is doubled when the amount wagered is doubled.

A wild symbol in slot machine style games substitutes for other symbols in order to complete winning combinations. A wild symbol may have a multiplier function in slot machine style games so that when a wild multiplier symbol completes a winning set of symbols, the standard award from that game is multiplied by the value of the multiplier. Thus, if three cherries pays $5.00, two cherries and a wild symbol with a 3× multiplier value pays $15.00.

Known wild symbols with multiplier functions are limited in flexibility and, therefore, in their ability to generate player excitement. Indeed, such known wild symbols have static multiplier values which can be discerned from a payout table. Thus, when a wild multiplier symbol appears, player anticipation is not maximized.

A need exists for slot machine style games using wild symbols with multiplier functions, where the multiplier value is dynamic and unknown to the player until he/she has won a game, thus increasing player anticipation and excitement.

### SUMMARY

In one embodiment, a method for a slot machine style game is disclosed. The method includes the steps of determining an outcome of the slot machine style game and displaying a plurality of game symbols corresponding to the outcome. At least one of the game symbols is a multiwild symbol, which comprises a wild symbol and has an award multiplier associated therewith. The method also includes the steps of determining whether at least a portion of the plurality of game symbols is a winning combination and when there is a winning combination determining a first award associated with the winning combination, wherein the multiwild symbol is treated as the wild symbol without the award multiplier; randomly generating the award multiplier; determining a second award based on the first award and the award multiplier; and providing the second award to a player.

Another embodiment describes a method for a slot machine style game. The method includes the steps of receiving a request to begin the slot machine style game and determining whether the request is valid. When the request is determined to be valid, the method includes the steps of determining an outcome of the slot machine style game and determining a plurality of game symbols to be displayed. At least one of the game symbols is a multiwild symbol, which comprises a wild symbol and has an award multiplier associated therewith. The method also includes the steps of determining whether at least a portion of the plurality of game symbols is a winning combination and when there is a winning combination determining a first award associated the winning combination, wherein the multiwild symbol is treated as the wild symbol without the award multiplier; randomly generating the award multiplier; determining a second award based on the first award and the award multiplier; and transmitting the plurality of game symbols, the award multiplier, the first award, and the second award.

Other embodiments of the disclosed slot machine style game will become apparent from the following detailed description, the accompanying drawings and the appended claims.

### BRIEF DESCRIPTION OF THE DRAWINGS

FIG. 1 is a hardware block diagram of an embodiment of the slot machine style game of the present disclosure.

FIG. 2 is a software flow diagram of an embodiment of the slot machine style game of the present disclosure.

FIG. 3 is a hardware block diagram of another embodiment of the slot machine style game of the present disclosure.

FIG. 4 is software a flow diagram of an another embodiment of the slot machine style game of the present disclosure.

FIGS. 5A-5C are exemplary screen sequences of an embodiment of the slot machine style game of the present disclosure.

### DETAILED DESCRIPTION

In the following detailed description of exemplary embodiments, reference is made to the accompanying drawings, which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical, software, processing, and other changes may be made without departing from the spirit or scope of the present invention. The following detailed description is, therefore, not to be taken in a limiting sense, and the scope of the present invention is defined only by the appended claims.

In traditional slot machine style games, a wild symbol is used to replace any other symbol in order to build a winning combination. The present disclosure improves on such additional games, adding to player excitement, by creating a new kind of wild symbol that performs multiple functions. First, as with traditional wild symbols, the new wild symbol is used to complete a winning combination across a horizontal, vertical, diagonal or other pay lines. Second, the new wild symbol triggers a randomly generated multiplier value that multiplies a pay line and thus serves to increase an award. This new wild symbol is referred to herein as a “multiwild” symbol, which in a preferred embodiment, acts as an “on reel” bonus feature.

The slot machine style game of the present disclosure may be played in a controlled environment, such as a physical or online casino. In this case, the award provided to a player is typically money or its equivalent. The subject game may also be played in a non-controlled environment, such as an internet game where the award may be points or something else of value.

The slot machine style game of the present disclosure may be implemented on a variety of hardware and software platforms. In one embodiment, the game is implemented as an app or other program on a smart phone, such as Apple's iPhone. It is to be understood that this is but one implementation; the game may also be implemented on a video slot machine, traditional mechanical slot machine, or other processor-based system, such as a tablet computer, laptop computer, or desktop computer.

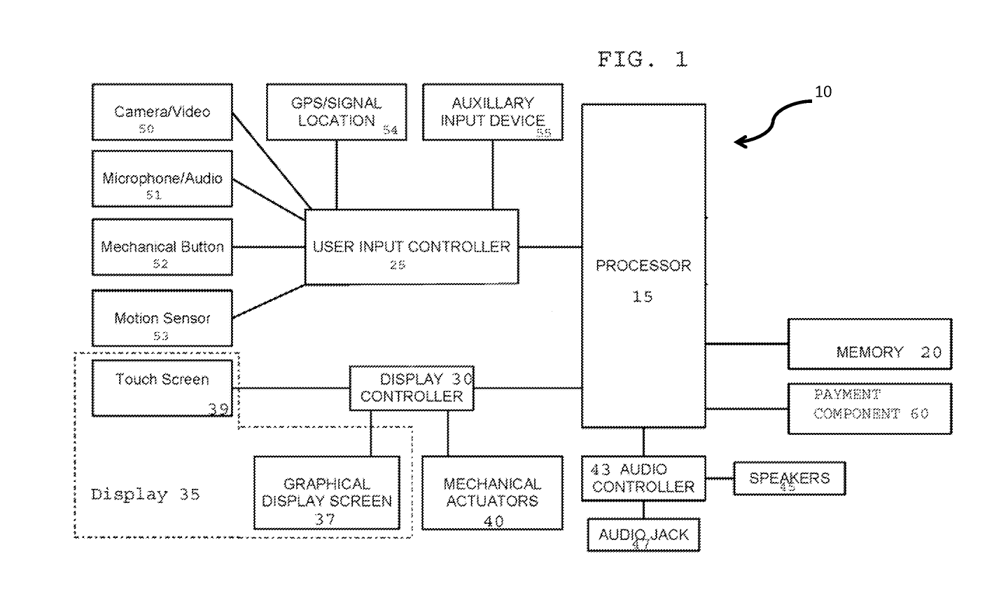

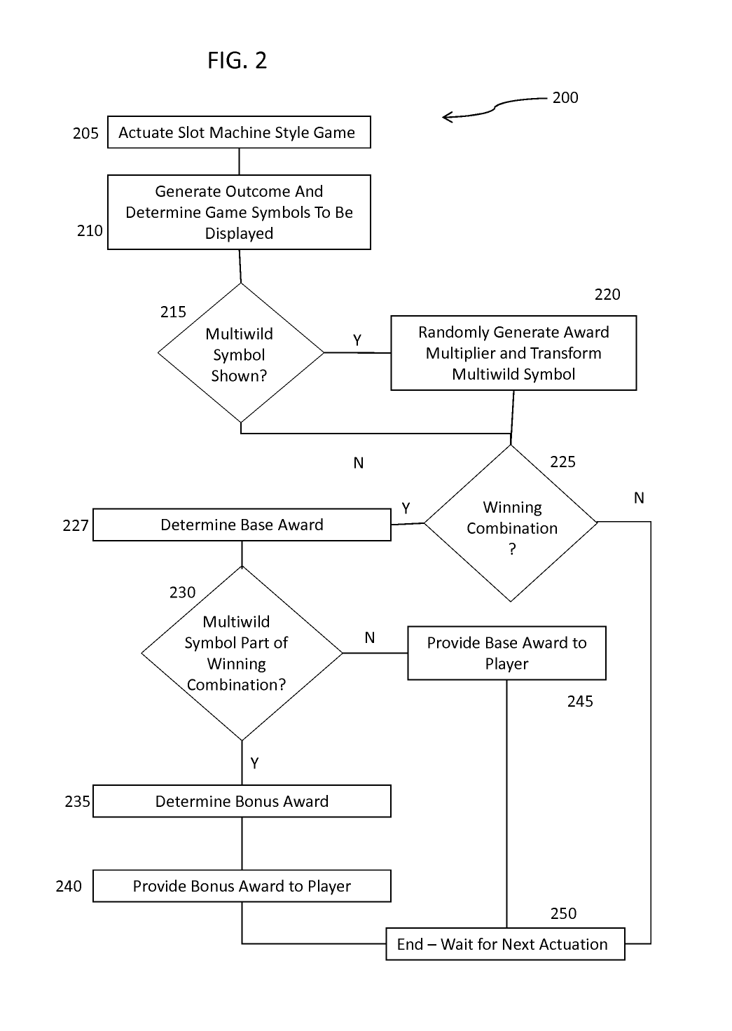

FIG. 1 illustrates the functional hardware units in one embodiment. A gaming device 10, such as a smart phone, includes processor 15, memory 20, display controller 30, and display 35.

In this embodiment, display 35 includes graphical display 37 and a touch screen 39. Graphical display 37 displays a plurality of game symbols to a player, preferably in a multitude of pay lines. Such symbols may include bells, hearts, fruits, numbers, letters, cards, bars, traditional wild symbols, the new multiwild symbol, and any other game symbols.

In this embodiment, graphical display 37 also displays means to enable player input. For example, a player may use buttons to indicate a number of payout lines to be included in a game and a number of coins to be wagered for each payout line. A button or virtual lever may also be displayed to actuate a game. Graphical display 37 also may be configured to display the total current wager and the total amount of awards won by a player.

Touch screen 39 allows for player interaction with the buttons and other images on graphical display 37. It emulates mechanical buttons, allowing for pressing, toggling, or other activation that transmits user interaction. A player makes decisions and inputs signals into gaming device 10 by touching the touch screen 39 at the appropriate places. Thus, a player uses the displayed buttons to indicate a number of payout lines to be included in a game and a number of coins to be wagered for each payout line. The player may touch a button to activate a game.

Display controller 30 is in communication with display 35, touch screen 39, and processor 15. It receives commands from touch screen 39 and outputs to graphical display 37 in response to commands received from processor 15.

Display controller 30 is also in communication with one or more mechanical actuators 40. These include elements that cause device 10 to vibrate and/or to fire a flash of a camera that is part of gaming device 10. In exemplary use, when a player wins a game, processor 15 may communicate with display controller 30 to cause the device 10 to vibrate and/or toggle the flash on and off.

In one embodiment, processor 15 manages and processes user inputs and causes display of game outcomes and awards. In an exemplary embodiment, processor 15 determines game outcomes, randomly generates an award multiplier for a multiwild symbol that is part of a winning combination, and causes awards to be provided to a player.

Processor 15 is in communication with memory 20. Memory 20 stores program code and instructions, executable by processor 15, to execute the slot machine style game and control gaming device 10. Memory 20 also stores other data such as image data, event data, player input data, random number generators, pay-table data or other operating data, information and applicable game rules that relate to the play of the slot machine style game. Memory 20 may include random access memory (RAM), read only memory (ROM), flash memory and/or EEPROM (electrically erasable programmable read only memory). Any other suitable magnetic, optical and/or semiconductor memory may be used with the device 10.

In one embodiment, an audio controller 43, is communication with processor 15, is used for outputting audio signals to audio outputs, such as speakers 45 or an audio jack 47.

In one embodiment, device 10 includes a user input controller 25, which is in communication with and may accept a signal from one or more input components 50-55 to actuate or otherwise provide data to the slot machine style game. User input controller 25 communicates with processor 15 to process the inputs.

A camera/video component 50 captures images and/or video that may contain a player's gestures or other expressions and sends that data, via user input controller 25, to processor 15 for interpretation and action. In one exemplary embodiment, camera/video component 50 may capture a player simulating the arm of a traditional slot machine being pulled. The data representing the image or video is sent, via user input controller 25, to processor 15, which may actuate the slot machine style game.

A microphone/audio component 51 captures speech or other audio that may contain commands or be subject to other interpretive action. Data representing the speech or other audio is transmitted to processor 15 for interpretation and action via user input controller 25. In an exemplary embodiment, a slot machine style game may be actuated when user says “SPIN” into the microphone. Similarly, when particular audio (for example, a song or other sound) is detected, the slot machine style game may be actuated.

A mechanical button or switch 52 on device 10 may be used to actuate the slot machine style game. For example, when a user presses, toggles, or activates the button 52 (for example, the volume increment button on an iPhone), the slot machine style game may be actuated.

A motion sensor component 53 captures movement, motion, acceleration, or other gyroscopically determinant values of device 10. Component 53 sends the corresponding data, via user input controller 25, to processor 15 for interpretation and action. Thus, for example, a player may waive device 10 from left to right to actuate the slot machine style game.

A GPS or other location detector 54 may be used to determine the location of device 10 as a variable. The location is transmitted to processor 15 via user input controller 25 for interpretation and action. Thus, when processor 15 determines that a player is in a designated location, the slot machine style game may be actuated and/or augmented. For example, when processor 15 determines that a player is in a gift shop of a casino, the award multiplier associated with the multiwild symbol may be increased.

An auxiliary input device 55 may be used to allow for physical, virtual, or other interactions that can be interpreted by device 10. In one embodiment, when input device 55 is a joystick connected to a smart phone, for example Apple's iPhone, the player can toggle the joystick to simulate a slot machine handle, which is interpreted by the input controller 25 as a game actuation request.

In embodiments in which money is wagered, a payment component 60 may be placed in communication with processor 15. Component 60 may be used to provide awards to the player or accept payment from a player. The awards may be in the form of money (e.g., cash, debit) or an equivalent thereof. Such equivalents include tokens, ticket, note, voucher, credits, and the like.

In a traditional slot machine embodiment, payment component 60 may include a coin or token slot or bill acceptor. A player can thus place coins in the coin slot or paper money, tickets, notes or vouchers into the bill acceptor.

In other embodiments, devices such as readers or validators for credit cards, debit cards, data cards or credit slips could be used for accepting payment. In one embodiment, a player may insert an identification card into a card reader of the gaming device. An identification card is a smart card having a programmed microchip or a magnetic strip coded with a player's identification, credit totals and other relevant information. In other embodiments, money may be transferred to a gaming device through electronic funds transfer. When a player funds the gaming device 10, the processor determines the amount of funds entered and the corresponding amount is shown on the credit or other suitable display as described above.

As described above, in one embodiment, memory 20 stores program code and instructions, executable by processor 15, to execute the slot machine style game and control gaming device 10. Processor 15 executes the program code in response to player or other interactions to perform the following steps of process 200.

At step 205, a slot machine style game is actuated. In one embodiment, actuation occurs when a player touches his/her finger on touch screen 39. The user may pull a lever, depress a spin button, or otherwise indicate that they would like a game to commence. In an alternate embodiment, actuation occurs based on an input from an input component 50-55.

At step 210, processor 15 randomly selects an outcome from a plurality of possible outcomes and thus determines a plurality of corresponding game symbols to be displayed and the locations on the reels to display such symbols. As is well known, the frequency by which certain game symbols and combinations thereof are displayed is proportional to the likelihood of different award eventualities. Processor 15 causes virtual reels shown on graphical display 37 to rotate and display the plurality of game symbols. When the reels stop, processor 15 causes the graphical display 37 to show the resulting plurality of symbols. Such symbols may include bells, hearts, fruits, numbers, letters, cards, bars, traditional wild symbols, the new multiwild symbol, and other game images.

At step 215, processor 15 determines whether at least one of the plurality of symbols displayed at step 210 is a multiwild symbol. If it is not, then processing continues at step 225. If there is a multiwild symbol, processing continues at step 220.

At step 220, processor 15 initiates an animation sequence on graphical display 37 to transform or otherwise modify the multiwild symbol. In one embodiment, the multiwild symbol is changed to indicate a factor by which a base award will be multiplied. The award multiplier may be superimposed over all or a part of the multiwild symbol that is part of the plurality of symbols displayed at step 210.

Displaying the transformed multiwild symbol as part of the plurality of symbols displayed at step 210 provides a significant feature of the present disclosure. Indeed, the anticipation of what the multiwild symbol will reveal creates the excitement similar to a complete secondary game spin where a player not only knows that they have won something already, but the possibility of winning a substantial quantity more is about to be known.

In an exemplary embodiment, processor 15 randomly (which herein includes pseudo-randomly) generates the award multiplier. The award multiplier may be based on criteria such as the location of the player's device 10, time of day, day of the week, or other known quantifiable values for the player like their age. In another embodiment, criteria dependent on previous play, such as, rate of game play, wager amount, special occasions known to the system, or any other precise or augmentable value a particular game instance may make known about the player.

At step 225, for each active pay line, processor 15 determines whether such pay line includes a winning combination. In one embodiment, the slot machine style game makes more pay lines available as a player progresses in the game. Special symbols can also be used to unlock extra pay lines for the subsequent spins.

The determination of whether such pay line includes a winning combination is done in a traditional manner, wherein a multiwild symbol is treated as a traditional wild symbol (i.e., as a placeholders for any other symbols, without regard to the award multiplier). If a winning combination is not present, then process 200 ends at step 250, where processor 15 waits for the next actuation. If winning combination is present, then processing continues at step 227.

At step 227, processor 15 calculates the amount of a base award without regard to the award multiplier. The base award may be determined from a payout table stored in memory 20.

At step 230, for the winning pay line, processor 15 determines whether such pay line includes a multiwild symbol. If it does not, then processing continues at step 245 where the base award is provided to the player. If it does, then at step 235, processor 15 then calculates a bonus award, for example, by multiplying the base award by the award multiplier generated at step 220.

At step 240, processor 15 may initiate a prize animation sequence and provide the bonus award to the player. The bonus award may be money, in the form of coins, tokens, credits. It may also be another thing of value to the player, such as points that the player is accumulating during play of the game. In one embodiment, processor 15 uses graphical display 37 to alert the player that he/she has won and to display the amount of the bonus award. Processor 15 updates total amount won by a player on graphical display 37. In another embodiment, processor 15 instructs display controller 35 to vibrate and/or to fire a flash of a camera that is part of device 10.

Processing may then end at step 250, where processor 15 waits for the next actuation.

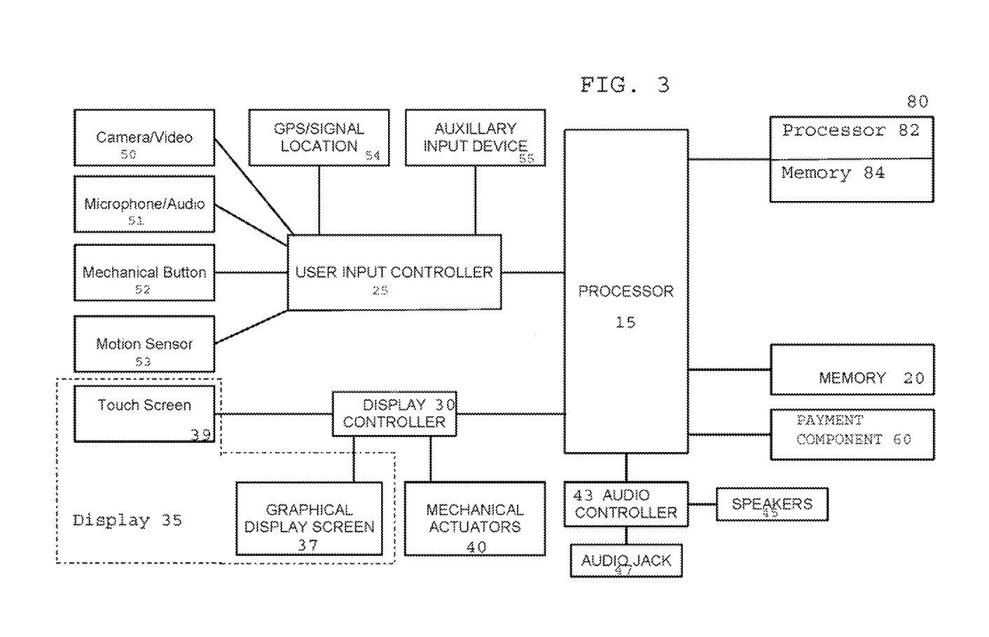

FIG. 3 shows the slot machine style game in an alternate distributed processing environment. Like reference numerals in FIG. 3 correspond to those in FIG. 1. In this embodiment, a gaming server or other network processor 80 may be used to determine game outcomes and symbols to be displayed, randomly generate an award multiplier for a multiwild symbol that is part of a winning combination, generate base and bonus awards, and transmit such information so it can be provided to a player.

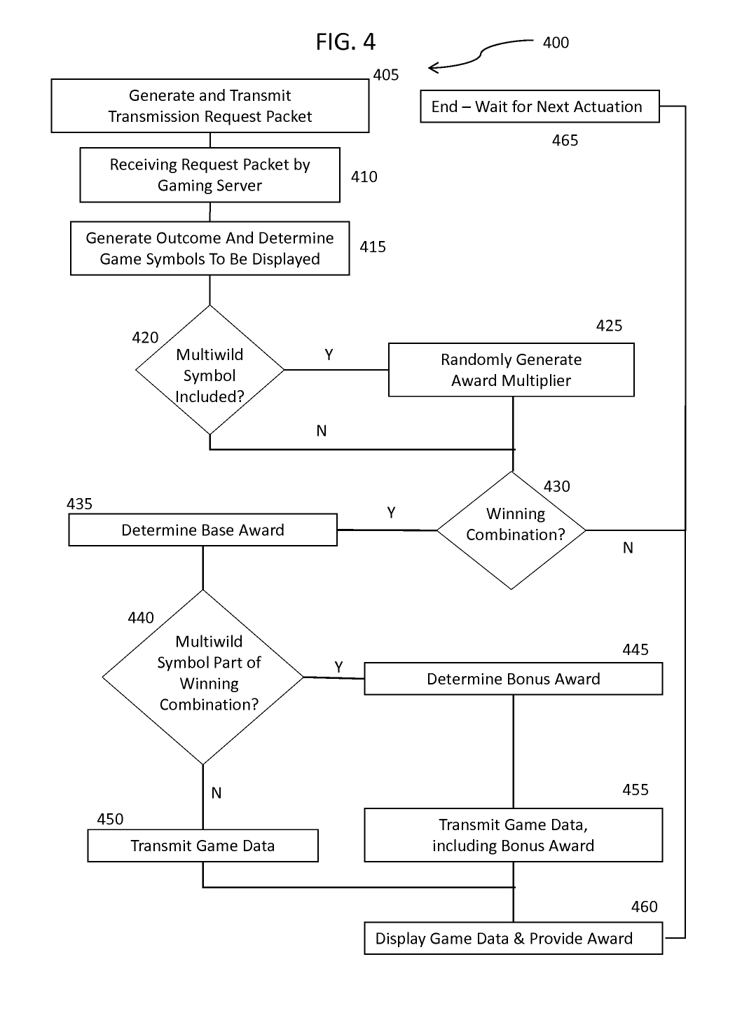

The gaming server 80 includes a processor 82 and memory 84. Memory 84 stores program code and instructions, executable by processor 80, to execute the slot machine style game and communicate with device 10. In one embodiment, processor 82 executes program code in response to player input communicated from gaming device 10 to perform the steps of process 400 of FIG. 4.

At step 405, processor 15 of a gaming device 10 generates a transmission request packet. In one embodiment, processor 15 compiles and packages credentialing data for gaming device 10 and the associated player. The credentialing data may include, for example, a unique device identification number, a unique hardware profiling, an authorization token received during setup, the player's username, phone number, password, or some combination thereof of these identifiers. Some or all of this data may serve as authentication credentials for the gaming device 10.

At step 410, processor 15 confirms the integrity of the transmission request packet. Thus, processor 15 determines that the data is complete and meets the protocol formatting requirements for gaming server 80.

At step 415, processor 82 randomly selects an outcome from a plurality of possible outcomes. Processor 82 determines a plurality of corresponding game symbols to be displayed and the locations on the reels to display such symbols. As above, the symbols may include bells, hearts, fruits, numbers, letters, cards, bars, traditional wild symbols, the new multiwild symbol, and other game images. The game symbols corresponding to the selected outcome will later be transmitted to processor 15 for display.

At step 420, processor 82 determines whether at least one of the game symbols determined by processor 82 at step 415 is a multiwild symbol. If it is not, then processing continues at step 430. If there is a multiwild symbol, processing continues at step 425.

At step 425, processor 82 randomly generates an award multiplier. The award multiplier may be based on criteria such as those describe above.

At step 430, for each active pay line, processor 82 determines whether such pay line includes a winning combination. This is done as described above. If a winning combination is not present, then process 400 ends at step 465, where processor 15 waits for the next actuation. If a winning combination is present, then processing continues at step 435.

At step 435, processor 82 calculates the amount of a base award without regard to the award multiplier. The base award may be determined from a payout table stored in memory 84.

At step 440, for the winning pay line, processor 82 determines whether such pay line includes a multiwild symbol. If it does not, then processing continues at step 450 where processor 82 transmits the plurality of game symbols and the base award to the gaming device 10. If it does, then at step 445, processor 82 then calculates a bonus award, for example by multiplying the base award by the award multiplier generated at step 425. Processor 82 transmits the plurality of game symbols, the award multiplier, the base award, and the bonus award to the gaming device 10 at step 455.

At step 460, processor 15 executes a prize animation sequence and displays the plurality of game symbols, the award multiplier, the base award, and the bonus award to player. Process 400 ends at step 465, where processor 15 waits for the next actuation.

Similar to process 200, the animation sequence is displayed graphical display 37 and includes the transformation or otherwise modification of the multiwild symbol. In one embodiment, the multiwild symbol initially displayed, and then is changed to indicate a factor by which a base award will be multiplied. The award multiplier may be superimposed over all or a part of the multiwild symbol that is part of the plurality of symbols displayed.

Displaying the transformed multiwild symbol as part of the plurality of symbols displayed provides a significant feature of the present disclosure. Indeed, the anticipation of what the multiwild symbol will reveal creates the excitement similar to a complete secondary game spin where a player not only knows that they have won something already, but the possibility of winning a substantial quantity more is about to be known.

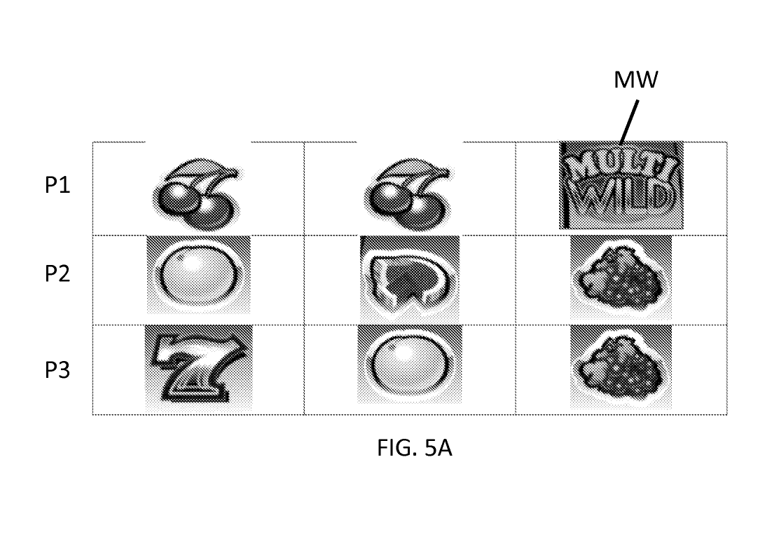

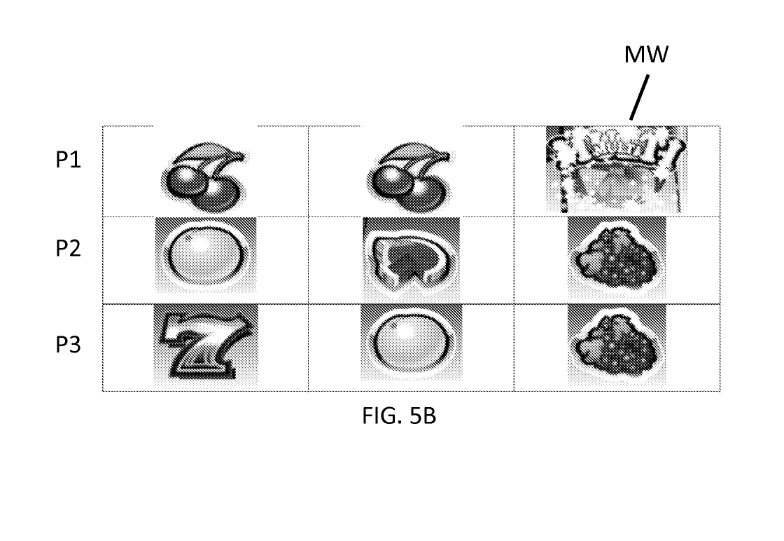

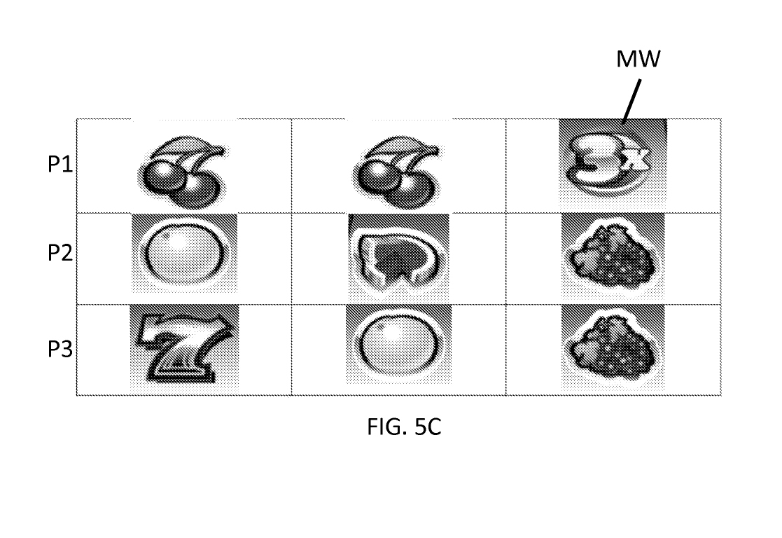

FIGS. 5A-5C are exemplary screen sequences and will serve to illustrate an example of the slot machine style game of the present disclosure.

A player wagers $5 and actuates the slot machine style game, for example, by pulling a virtual lever on touch screen 39. Processor 15 randomly selects an outcome from a plurality of possible outcomes and thus determines a plurality of corresponding game symbols to be displayed and the locations on the reels to display such symbols. Processor 15 causes virtual reels shown on graphical display 37 to rotate and display the plurality of game symbols. When the reels stop, processor 15 causes the graphical display 37 to show the resulting plurality of symbols. As shown in FIG. 5A, display 37 shows three horizontal pay lines: P1 shows CHERRY-CHERRY-MULTIWILD; P2 shows LEMON-WATERMELON-GRAPES; and P3 shows SEVEN-LEMON-GRAPES.

Processor 15 determines that at least one of the plurality of symbols displayed is the multiwild symbol, here, symbol MW in FIG. 5A. Processor 15 randomly generates the award multiplier and initiates an animation sequence on graphical display 37. As shown in FIGS. 5B and 5C, processor 15 transforms multiwild symbol to indicate a factor by which a base award will be multiplied. As shown in FIG. 5C, the award multiplier is 3×.

For each active pay line, here P1-P3, processor 15 determines that pay line P1 depicts a winning combination. The determination is done in a traditional manner. The multiwild symbol MW is treated as a traditional wild symbol (i.e., as a placeholders for any other symbols, without regard to the award multiplier) such that the winning combination is interpreted as CHERRY-CHERRY-CHERRY.

Processor 15 calculates the amount of a base award CHERRY-CHERRY-CHERRY without regard to the award multiplier. The base award may be determined from a payout table stored in memory 20.

For the winning pay line P1, processor 15 determines that it includes a multiwild symbol MW. Processor 15 calculates a bonus award, for example, by multiplying the base award of $10 by the 3× award multiplier. Thus, the bonus award would be $30.

Processor 15 initiates a prize animation sequence and provides the bonus award to the player—for example, by adding points to the player's account.

Although various embodiments of the disclosed slot machine style game have been shown and described, modifications may occur to those skilled in the art upon reading the specification. The present application includes such modifications and is limited only by the scope of the following claims.

We claim:

1. A method for a slot machine style game, comprising the steps of:
a. determining an outcome of the slot machine style game;
b. displaying a plurality of game symbols corresponding to the outcome, wherein at least one of the game symbols is a multiwild symbol, wherein the multiwild symbol comprises a wild symbol and has an award multiplier associated therewith;
c. determining whether at least a portion of the plurality of game symbols is a winning combination; and
d. when there is a winning combination
i. determining a first award associated with the winning combination, wherein the multiwild symbol is treated as the wild symbol without the award multiplier;
ii. randomly generating the award multiplier;
iii. determining a second award based on the first award and the award multiplier; and
iv. providing the second award to a player.

2. The method of claim 1, wherein step (a) comprises displaying the plurality of game symbols, wherein at least one of the symbols is the multiwild symbol, and wherein each multiwild symbol indicates the award multiplier.

3. The method of claim 1, further comprising, after step (d)(ii), transforming the multiwild symbol into a different symbol after the multiwild symbol is displayed.

4. The method of claim 3, wherein the step of transforming comprises changing the multiwild symbol into a different symbol after the multiwild symbol is displayed, wherein the transformed symbol indicates the award multiplier, and displaying the transformed symbol.

5. The method of claim 3, wherein the step of transforming comprises changing the multiwild symbol into a different symbol after the multiwild symbol is displayed, wherein each transformed symbol indicates the award multiplier, and displaying the transformed symbol in place of the multiwild symbol.

6. The method of claim 1, wherein steps (c) and d(i)-(iii) are carried out on a first device, and the remaining steps are carried out on a second device, wherein the first device differs from the second device.

7. The method of claim 1, further comprising the step of actuating the slot machine style game using an input selected from the group consisting of a touch screen input, a motion sensor, a mechanical button, a microphone, a camera, and an auxiliary input device.

8. The method of claim 1, wherein the player has a location associated therewith, further comprising the steps of
a. increasing the second award based on the location of the player; and
b. displaying the increased second award to the player.

9. The method of claim 1, wherein the player plays the slot machine style game on a device, wherein the device has a camera with a flash associated therewith, further comprising the step of lighting or toggling the flash when the plurality of game symbols is a winning combination.

10. The method of claim 1, wherein the player plays the slot machine style game on a device, wherein the device has a camera with a flash associated therewith, wherein the device vibrates when the plurality of game symbols is a winning combination.

11. The method of claim 1, wherein the step of providing the second award to the player comprises displaying the second award to the player or updating an account associated with the player.

12. The method of claim 1, wherein the step of providing the second award to the player comprises providing money or the equivalent thereof to the player.

13. A method for a slot machine style game, comprising the steps of:
a. receiving a request to begin the slot machine style game and determining whether the request is valid;
b. when the request is determined to be valid,
i. determining an outcome of the slot machine style game;
ii. determining a plurality of game symbols to be displayed, wherein at least one of the game symbols is a multiwild symbol, wherein the multiwild symbol comprises a wild symbol and has an award multiplier associated therewith;
iii. determining whether at least a portion of the plurality of game symbols is a winning combination; and
iv. when there is a winning combination
1. determining a first award associated the winning combination, wherein the multiwild symbol is treated as the wild symbol without the award multiplier;
2. randomly generating the award multiplier;
3. determining a second award based on the first award and the award multiplier; and
4. transmitting the plurality of game symbols, the award multiplier, the first award, and the second award.

14. The method of claim 14, wherein the step (b)(iv)(4) comprises transmitting the plurality of game symbols, the award multiplier, the first award, and the second award to a device associated with a player.

15. The method of claim 15, further comprising the step of displaying the plurality of game symbols, including the multiwild symbol to a player.

16. The method of claim 15, further comprising, after step (b)(iv)(2), transforming the multiwild symbol into a different symbol after the multiwild symbol is displayed.

17. The method of claim 16, wherein step of displaying the plurality of game symbols and the step of displaying the transformed symbol are performed on the same screen.
